(19) United States
(12) Patent Application Publication
(10) Pub. No.: US 2008/0000224 A1
(43) Pub. Date: Jan. 3, 2008

(54) Ocean wave energy converter

(76) Inventor: Paul Swart, San Jose, CA (US)

Correspondence Address: PAUL SWART, #301, 1270 OAK MEAD PARKWAY, SUNNYVALE, CA, 94085, US

(21) Appl. No.: 11/479,859

(22) Filed: Jul. 3, 2006

(51) Int. Cl. F03B 17/02; F03B 13/18

(52) U.S. Cl. 60/497; 60/495

(57) ABSTRACT

A system is described for converting the energy contained in each ocean wave into mechanical energy used to drive an electric generator. The system is built around a large weight that sits atop an air-filled raft inside a chamber that is partly open to the ocean on one side. Water from each incoming wave pushes the raft upward in the chamber. As the water level subsides, the weight exerts a pulling force onto a gear system that in turn drives a standard electrical generator. The system is simple in design, it is highly scalable and inexpensive to construct with off-the-shelve components and building materials.

### BACKGROUND OF THE INVENTION

Ocean waves move large bodies of water forward. Therefore, each ocean wave contains a large amount of kinetic energy. Mathematically, this is defined as one-half the product of a wave's mass and the square of its speed.

For generations inventors have made efforts to harness this kinetic energy and convert it into electricity. A variety of devices and systems have been developed over the years and many are operating in different places around the globe.

A number of patents have been rewarded in this field:

### US Patent # Description

7,012,340 Apparatus for converting ocean wave energy into electric power
6,622,483 Ocean wave energy extraction system and components thereof
6,360,534 Ocean wave energy extraction
5,808,368 Ocean wave energy conversion device
5,708,305 Ocean wave energy conversion system
5,136,173 Ocean wave energy conversion system
4,748,338 Ocean wave energy extracting erosion reversal and power generation system
4,685,296 Ocean wave energy conversion using piezoelectric material members
4,672,222 Ocean wave energy converter
4,608,497 Ocean wave energy converting vessel
4,599,858 Ocean wave energy device
4,359,868 Ocean wave energy converter
4,345,434 Sea and ocean wave energy converter
4,232,230 Ocean wave energy converter
4,178,517 Process for conversion of ocean wave energy into electric power and apparatus

Some system use the back-and forth motion of the water. Others use the up-and down motion of the wave. And as recent as Jun. 28, 2006, San Francisco Mayor Gavin Newsom made public his city's plans to build a set of large turbines on the ocean floor below the Golden Gate Bridge. These will be driven by the back-and-forth movement of tidal water that flows in and out of the San Francisco Bay each day.

Although they all produce electricity, most of the created systems to date suffer from one or two drawbacks:
Inefficiency: The systems capture only a relatively small portion of the total available kinetic energy in each wave, limiting the scalability of the systems and thus the amount of electricity these systems can produce.
Complexity: While certainly impressive, many systems are so complex they are very expensive to build. And systems that rely on the electrical generator components to be placed under water also add a component of risk in that they are very difficult and expensive to service and repair, and they are highly subject to the corrosive effect of salt ocean water.

The system described in this patent application, in contrast, captures a large amount of the wave's energy and the system can be built entirely with inexpensive off-the shelf component.

### SUMMARY OF THE INVENTION

This invention provides a unique, simple, highly scalable and low-cost method for converting a large amount of energy stored in each ocean wave in to mechanical force that can power a standard electric generator. The system revolves around an air-filled platform (raft) and a large weight placed atop the raft. The raft moves up and down in the semi-closed chamber as each wave moves the water level inside the chamber up and down. During the downward movement of the water, the weight exerts a pulling force on a gear system at the top of the chamber. The gear system, in term, drives a standard electric generator. Thus ocean wave energy is efficiently converted into electric energy.

System for converting ocean wave energy into electricity

### BRIEF DESCRIPTION OF THE DRAWINGS

FIG. 1 is a side-view cross section of the system in a configuration that is anchored to the ocean bottom (as opposed to attachment to a cliff side).

FIG. 2 is a top-view showing how the wave amplifier wall s will channel a larger portion of a wave into the chamber at the end of the walls

FIG. 3 is a side view of the Downflow Accelerator Vent system. The top image show the vent door position when water moves down in the chamber, while the lower image shows the vent door pushed shut by the incoming wave water.

### DETAILED DESCRIPTION OF SPECIFIC EMBODIMENTS

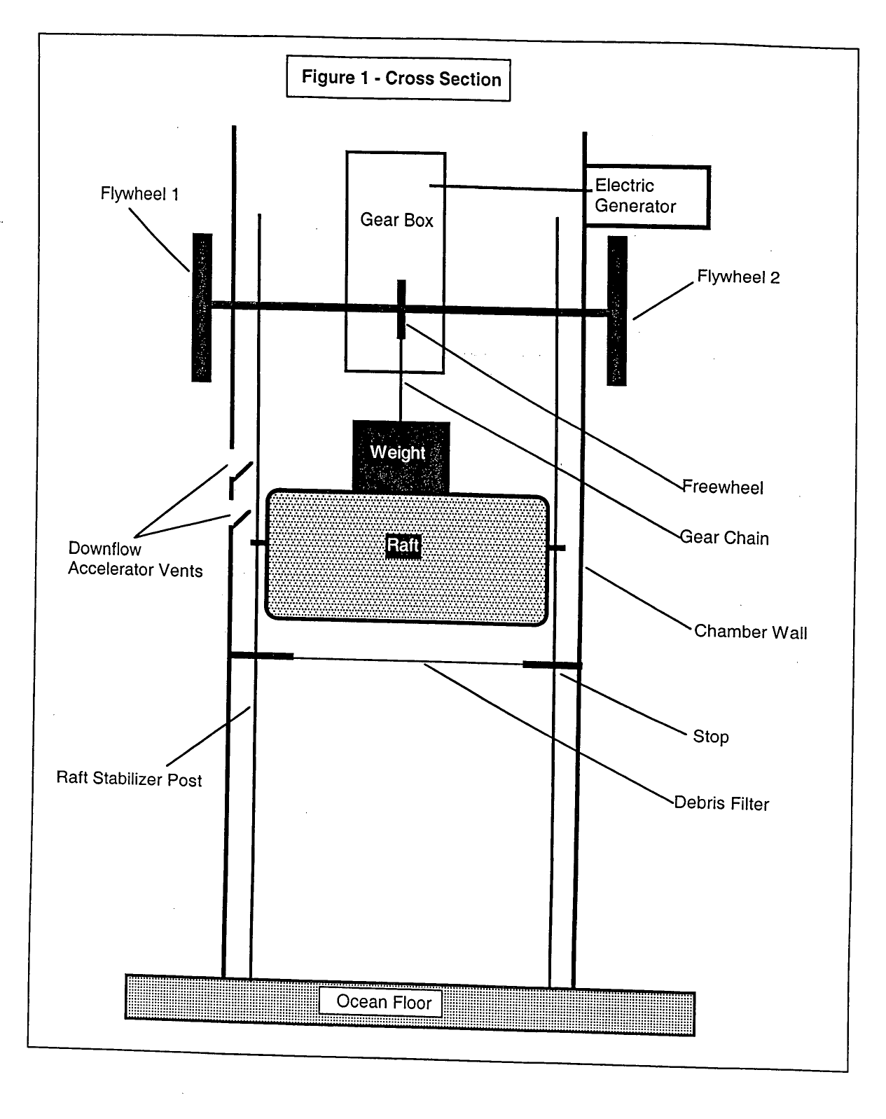

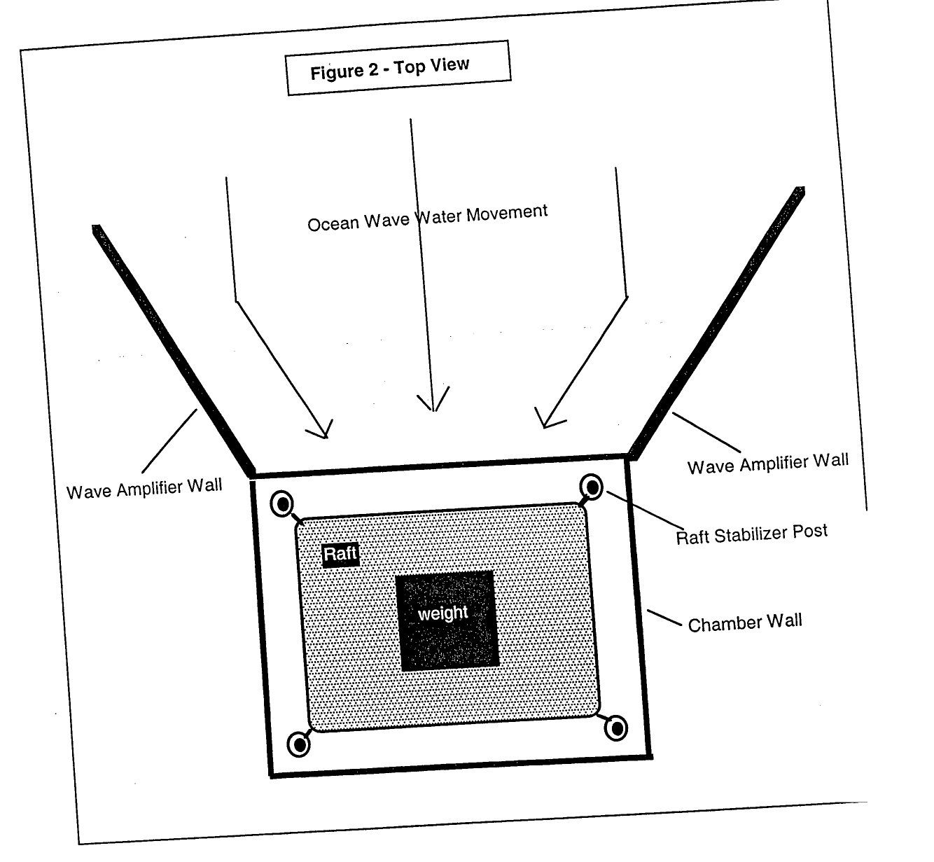

FIG. 1 shows a cross section of the system where a weight is placed atop an air filled raft in side a vertical chamber. Ocean wave water enters at the bottom of the chamber, pushing the raft upward. As the water resides, the weight, connected to a gear box by way of a gear chain, will exert a pulling force onto the gear box which is attached to a standard electrical generator. Following is a detailed description of the operation of the system
1. An air-filled platform (raft) is placed in a vertical chamber.
2. The chamber can be attached to the side of an ocean cliff, or can be mounted on a frame that is secured to the ocean floor. The size and shape of the chamber is determined by the size and shape of the raft. In this example a square design is used. A rectangular deign is likely to be typical. The chamber is slightly larger than the size and shape of the raft. If the raft measures 1 m×1 m, for example, the chamber would measure 1.2 m×1.2 m. The additional space between the raft and the chamber wall is needed for the Water Exit Vents (see #14 below).
3. The raft is held in place by 4 (or more) vertical posts. (see FIG. 2) Ring-type fasteners extend from each corner of the raft and the posts are placed through the rings. Thus, the raft can move freely up and down with each wave, but cannot wobble or bounce into the chamber walls.
4. At the center of the raft a weight is placed. In this patent description, we'll use as example a weight of 500 kilograms (0.5 metric ton) and a raft measuring 1 m×1 m×1 m.
5. The 500 kg of weight causes 50 cm (50%) of the raft to be submerged below the waterline. Thus the raft continues to easily move up and down with each wave. Up to 75% of the raft can be submerged before impacting the up and downward mobility of the raft.
6. On the side of the chamber that faces the ocean, an opening at the water level allows water from each wave to enter and exit the chamber. The forward force of the wave will cause the water level in the chamber to rise higher then the height of the wave at the point when it slams into the chamber. In nature this can be observed in Hawaii and other places in the form of “Blow Holes.”
7. From the center of the raft a gear chain extends upward and is pulled over a “freewheel.” A small weight at the end of the chain ensures that the chain moves smoothly up and down with the movement of the raft.
8. When the raft moves upward in the chamber, the freewheel moves backward without exerting any force onto the gear system. When the water level in the chamber recedes, the downward-moving weight will exert a pulling force onto the chain, which in turn causes the freewheel to lockup and allow the pulling force from the weight to be passed onto the gear system.
9. The maximum amount of force that can be applied to the gear system in this manner is close or equal the size of weight, or 1,100 pounds of force in our example.
10. A standard electric generator attached to the gear system will produce electricity as the weight continues to exert a pulling force with each passing wave.

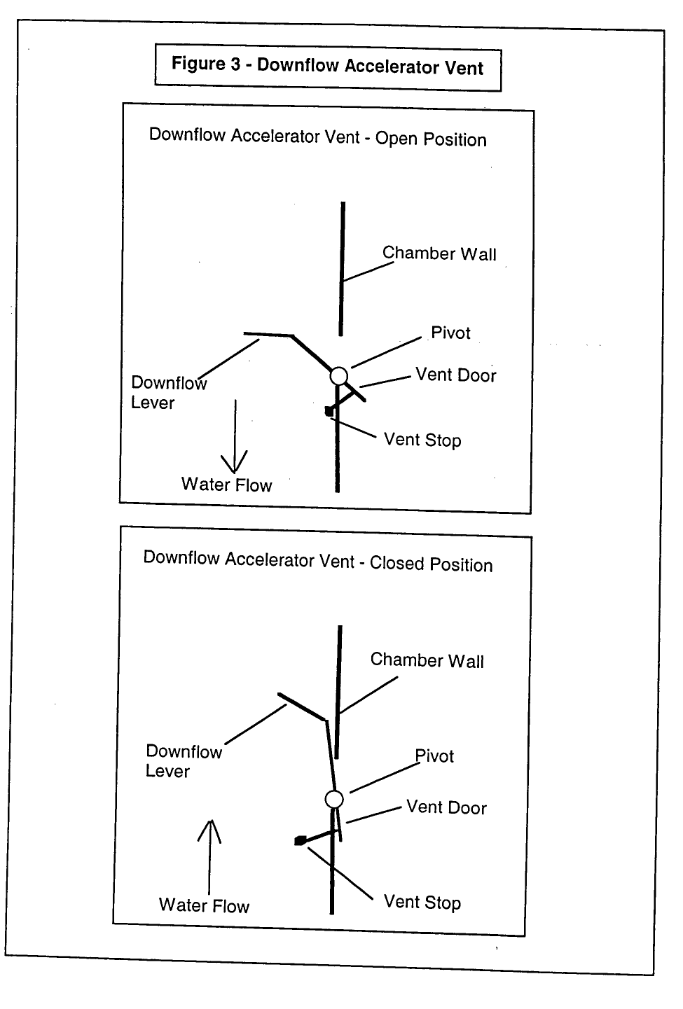

To increase the efficiency of the system, several additional components are added to the system:
1. Downflow Acceleration Vents—See FIG. 3: Built into the chamber walls are Downflow Accelerator vents that cause the water level in the chamber to subside at an accelerated rate. The pivoting vent doors are pushed into a closed position by the rising water. When the water level starts to decline, the downward force pushes the vents to the open position. As a result the water level in the chamber subsides faster than the downward movement of the raft. This causes the raft to “hang” in the air for several seconds, allowing it to exert the maximum amount of puling force onto the gear system as there is no water to hold it back.
2. Fly Wheels—See Image #1: The gear system is equipped with two heavy fly wheels on each end of one of the gear shafts. As the flywheels reach a desired RPM, they ensure that energy is delivered continuously to the generator during the phase when the raft moves upward with the water from a new wave entering the chamber.
3. Wave Amplifier Channel (optional)—See FIG. 2: In areas where waves are modest in size (3-4 feet), the system can be equipped with an wave amplification system. This consists of 2 walls extending outward into the ocean in a “V” shape at 20-40% angles each. This creates a narrowing channel ending at the opening of chamber. The channel causes a wider section of the wave to be forced into the chamber and will push the water level in the chamber higher than would have been achieved without the amplifying wave channels. Note: An example of the effect of the Wave Amplifier Channel in nature can be found on the island of Oahu, Hi. Inside the Hanauma Bay park, a phenomenon commonly known as “The Toilet Bowl” is a small bowl (about 8 feet deep and 10 feet in diameter) that sits behind rocks at the end of a 300-feet V-shaped channel. Even waves measuring just 1-2 foot traveling down the channel will cause the water inside the bowl to rise 4-8 feet, hence the term “Toilet Bowl” as it appears the pond is “flushed” out after each wave.

What is claimed:

1: A system for generating of electricity from an ocean wave by using a large weight, placed atop an air-filled platform/raft inside a semi-closed chamber, in order to exert a pulling force onto a gear/generator system when water recedes from the chamber.

2: A system to amplify the water level in the system chamber by extending two walls outward into the ocean in 20-40 degree angles, which will channel a larger section of a wave into the chamber and thus increasing the amount of energy that can be delivered to the gear system and electric generator.

3: A system to accelerate the decrease of the water level in the chamber by using special downflow accelerator vents that are closed by the upward force of the rising water level, and which are subsequently pushed open by the downward force from the water as it is exiting the chamber.
